(19) United States
(12) Patent Application Publication
(10) Pub. No.: US 2003/0230906 A1
(43) Pub. Date: Dec. 18, 2003

(54) Fibrous article gripper, kit and method

(75) Inventors: Robert Alfred Bennett, Stratford, CT (US); Liam Anthony Murray, Monroe, CT (US); Dennis Irwin Steiger, Danbury, CT (US)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/174,140

(22) Filed: Jun. 18, 2002

(51) Int. Cl. B25B 9/02

(52) U.S. Cl. 294/99.2; 294/25

(57) ABSTRACT

A gripper, kit and method is provided for manipulating fibrous balls and pads. The gripper includes first and second legs extending outwardly away from one another and joined at a pivot bridge, the legs being flexibly bendable by finger pressure in a direction toward one another for grabbing onto the fibrous ball or pad. A retention means such as a ring is joined to the legs or bridge. The ring allows the gripper to remain on a user's hand even though the fingers release pressure against the legs to disengage the grabbed ball or pad.

### BACKGROUND OF THE INVENTION

1. Field of the Invention

The invention concerns a gripper for handling fibrous articles, particularly cotton balls and pads without soiling fingers.

2. The Related Art

Cotton balls or pads are extensively utilized for transferring a solvent to a surface. For instance, remover fluid is applied to nail polish for removing this colorant from the nails. Acetone and ethyl acetate are generally the fluids of choice. These exhibit the side effect of de-fatting the fingers thereby impairing the stratum corneum.

Medical practices also utilize cotton balls or pads soaked in solvent fluid for purposes of medical procedures. Alcohols are the solvents of choice. Illustrative is the use of an alcohol swab to sterilize an area of the skin in preparation for removing blood samples.

Although less de-fatting than nail polish remover, repeated use of alcohol can also take its toll on the stratum corneum. Clearly there is a need for insulating fingers from a fluid soaked absorbent article.

Accordingly, it is an advantage of the present invention to provide a device, method and kit whereby an absorbent substrate such as cotton can be handled without soiling the fingers.

### SUMMARY OF THE INVENTION

A gripper is provided which includes:

first and second legs extending outwardly away from one another and joined at a pivot bridge, the legs being flexibly bendable by finger pressure in a direction toward one another for grabbing onto an article; and

a retention means joined to the legs or bridge for attachment to a finger, the retention means remaining on the finger as the finger pressure against the legs is released to disengage the grabbed article from the gripper.

Further, there is provided a method for applying a solvent to a surface without soiling the fingers, the method including:

(i) providing a fluid absorbent ball or pad;

(ii) gripping the ball or pad with a gripper as described above;

(iii) contacting the gripped ball or pad with a solvent for impregnation of fluid into the ball or pad;

(iv) applying the fluid impregnated ball or pad to a treatment surface; and

(v) disposing of the ball or pad by releasing pressure on the legs of the gripper.

Advantageously all elements of the gripper are formed as a unitary piece. This may be accomplished by plastic extrusion molding of the legs, bridge and retention means as a single item. Suitable plastics include low density polyethylene and polypropylene. These plastics provide sufficient elasticity allowing the legs to easily be pressed inward by the fingers yet being springedly flexible to return to an original open position.

The retention means in a preferred embodiment is a ring. Preferably the ring is formed on the bridge. In this embodiment the bridge can serve as part of a circumference of the ring. Advantageously a plane of the ring bisects an angle formed by the outwardly extended legs. Alternatively the retention means may be any polygonal structure other than circular. Illustrative is a triangle, square, oval or rectangular shape. In a still further possible embodiment, the retention means may be a partial ring missing a section along a circumference thereof. The missing circumference may range in size from about 5° to about 9020 arc, preferably from about 10° to about 60° arc.

The ring need not necessarily be formed onto the bridge. In a less preferred embodiment, the ring can be formed onto the legs.

The legs can extend outwardly from the bridge at an angle between about 10° and about 70°, preferably between about 20° and about 60°, optimally from about 40° to about 50°.

A further feature of the gripper in a preferred embodiment includes a foot projecting outwardly from each leg. The foot serves as a splash guard or stop preventing fingers from going into the fibrous fluid soaked ball. This avoids soiling the fingers from nail polish removal. Where the balls are intended for medical use and required to remain sterile, each foot prevents the fingers from contaminating the sterility of the ball.

Another useful feature for the gripper is the presence of a plurality of rungs on an inner surface of each leg near an end distant from the bridge. Particularly useful is an arrangement where the rungs on one leg are arranged to fit between spaces separating rungs on the other leg, when pressure is applied forcing the legs inward against one another. Interlocking of the rungs in this manner improves grippability and allows for clean release of the fibrous ball or pad.

Still a further feature useful for the present invention is to have correct dimensions. Each leg may have a width ranging from about 0.25 to about 0.75 inches (about 0.6 to about 1.9 cm), optimally about 0.5 inches (about 1.3 cm). Each leg may have a length, which extends from the bridge to an opposite end thereof, ranging from about 0.75 to about 2 inches (about 1.9 to about 5.1 cm), optimally about 1.25 inches (about 3.2 cm). Relative ratios of width to length for the legs may range from about 1:8 to about 1:1, optimally about 1:2.5.

### BRIEF DESCRIPTION OF THE DRAWING

Further advantages and features of the present invention will become more readily apparent from consideration of the drawing in which:

FIG. 1 is a plan perspective view of a first embodiment;

FIG. 2 is a cross-sectional view along 2-2 of FIG. 1;

FIG. 3 is a top plan view of the embodiment shown in FIG. 1;

FIG. 4 illustrates the method of grabbing a cotton ball through use of the gripper;

FIG. 5 shows release of the cotton ball grabbed through the motion shown in FIG. 4;

FIG. 6 is a side elevational view of the gripper according to FIG. 1;

FIG. 7 is a cross sectional view of a second embodiment of the gripper wherein the ring attaches to the legs; and

FIG. 8 is a third embodiment of the gripper wherein the ring has a missing circumferential section.

### DETAILED DESCRIPTION OF THE INVENTION

Tweezers have been used to manipulate cotton balls or pads and related articles. However, there is a basic problem with their operation. As the cotton is released from jaws of the tweezer, the fingers of the hand must part to release their pressure against legs of the tweezer. As finger grip is loosened, there is a significant likelihood the fingers will also cause loss of grip on the tweezer itself thereby dropping the tweezer. The present invention has solved this problem. A ring mechanism allows failsafe retention of the gripping device on the hand as fingers release pressure to allow release of the cotton from jaws of the gripper.

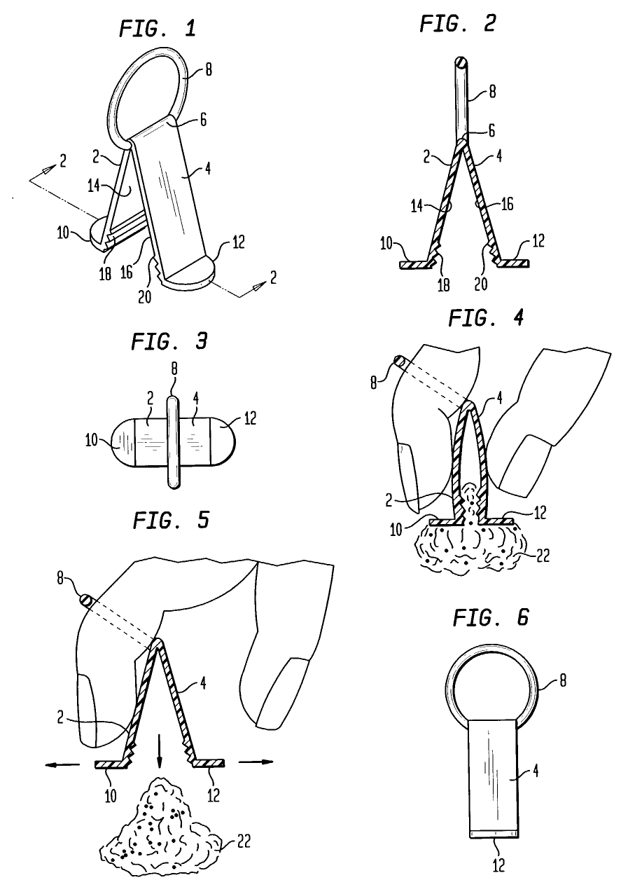

FIG. 1 illustrates a preferred embodiment of the gripper invention. The gripper features first and second legs 2, 4 which extend outwardly away from each other. These legs are joined at a pivot bridge 6. A ring 8 is formed on the bridge and utilizes at least part of the bridge to form a circumference of the ring.

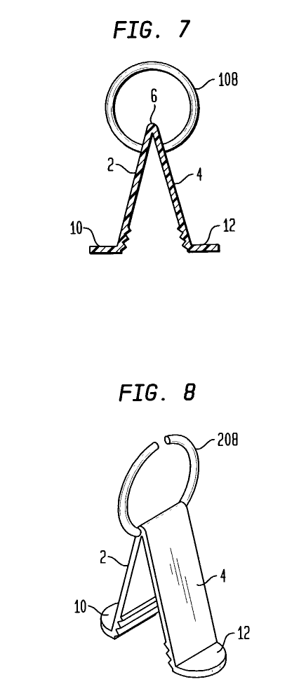

In an alternative embodiment, the ring 108 can project, and be unitarily molded with, the legs 2, 4. This embodiment is shown in FIG. 7. A still further embodiment is shown in FIG. 8 wherein the ring is a partial ring 208 with a missing section along a circumference thereof.

In the preferred embodiment, the legs are each provided with a foot 10, 12. These respective feet are directed away from one another at the ends of the respective legs.

Advantageously on an inner surface 14, 16 of respective first and second legs are a series of rungs. One set of rungs 18 are arranged so that when they are squeezed against rungs 20 they can engage spaces between rungs 20 and interlock.

FIG. 4 illustrates the method of the present invention. A user's index finger slips through ring 8 and the index finger and thumb place pressure against legs 2, 4. The gripping position captures cotton ball 22.

FIG. 5 demonstrates release of the cotton ball by release of some pressure against leg 4. Even though removal of the thumb frees the gripper from grip of a user's fingers, ring 8 allows the gripper to be retained on the hand.

Except in the operating and comparative examples, or where otherwise explicitly indicated, all numbers in this description indicating amounts of material ought to be understood as modified by the word “about”.

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

The foregoing description and examples illustrate selected embodiments of the present invention. In light thereof variations and modifications will be suggested to one skilled in the art, all of which are within the spirit and purview of this invention.

What is claimed is:

1. A gripper comprising:
first and second legs extending outwardly away from one another and joined at a pivot bridge, the legs being flexibly bendable by finger pressure in a direction toward one another for grabbing onto an article; and
a retention means joined to the legs or bridge for attachment to a finger, the retention means remaining on the finger as the finger pressure against the legs is released to disengage the grabbed article from the gripper.

2. The gripper according to claim 1 wherein the legs, bridge and retention means are formed as a unitary piece.

3. The gripper according to claim 1 wherein the retention means is a ring.

4. The gripper according to claim 1 wherein the retention means has a polygonal structure.

5. The gripper according to claim 3 wherein the ring is formed onto the bridge.

6. The gripper according to claim 5 wherein a section of the bridge is part of the ring.

7. The gripper according to claim 5 wherein a plane of the ring bisects an angle formed by the outwardly extending legs.

8. The gripper according to claim 1 wherein the Legs extend outwardly from the bridge at an angle between about 10° and about 70°.

9. The gripper according to claim 8 wherein the angle is between about 40° and about 50°.

10. The gripper according to claim 1 wherein the retention means is a partial ring missing a section along a circumference thereof.

11. The gripper according to claim 10 wherein the missing circumference ranges in size from about 5° to about 90° arc.

12. The gripper according to claim 3 wherein the ring is formed on the legs.

13. The gripper according to claim 1 further comprising a foot projecting outwardly from each leg.

14. The gripper according to claim 1 further comprising a plurality of rungs on an inner surface of each leg near an end distant from the bridge, the inner surfaces facing one another.

15. The gripper according to claim 14 wherein the rungs on one leg are interlocked against space separating rungs on the other leg, when pressure is applied forcing the legs inward against one another.

16. The gripper according to claim 1 wherein each leg has a width and a length in a ratio ranging from about 1:8 to about 1:1 .

17. The gripper according to claim 16 wherein the ratio is about 1:2.5 .

18. A kit comprising:
(i) at least one absorbent applicator; and
(ii) a gripper for applying the applicator to a surface, the gripper comprising:
first and second legs extending outwardly away from one another and joined at a pivot bridge, the legs being flexibly bendable by finger pressure in a direction toward one another for grabbing onto an article; and
a retention means joined to the legs or bridge for attachment to a finger, the retention means remaining on the finger as the finger pressure against the legs is released to disengage the grabbed article from the gripper.

19. The kit according to claim 18 wherein the absorbent applicator is a cotton ball or pad.

20. A gripper comprising:
first and second legs extending outwardly away from one another and joined at a pivot bridge, the legs being flexibly bendable by finger pressure in a direction toward one another for grabbing onto an article; and
a ring joined to the legs or bridge for attachment to a finger, the ring remaining on the finger as the finger pressure against the legs is released to disengage the grabbed article from the gripper, each leg having a width and a length in a ratio ranging from about 1:8 to about 1:1 .

21. A method for applying a solvent to a surface without soiling fingers or contaminating the solvent with microorganisms from the fingers, the method comprising:
(i) providing a fluid absorbent ball or pad;
(ii) gripping the cotton ball or pad with a gripper comprising:
first and second legs extending outwardly away from one another and joined at a pivot bridge, the legs being flexibly bendable by finger pressure in a direction toward one another for grabbing onto an article; and
a retention means joined to the legs or bridge for attachment to a finger, the retention means remaining on the finger as the finger pressure against the legs is released to disengage the grabbed article from the gripper;
(iii) contacting the gripped ball or pad with a solvent for impregnation of fluid into the ball or pad;
(iv) applying the fluid impregnated ball or pad to a treatment surface;
and
(v) disposing of the ball or pad by releasing pressure on the legs.
